(19) United States
(12) Patent Application Publication
(10) Pub. No.: US 2011/0320249 A1
(43) Pub. Date: Dec. 29, 2011

(54) Reward Based Media Distribution System

(76) Inventor: NICOLAS PLACIDE, Miami, FL (US)

(21) Appl. No.: 12/825,119

(22) Filed: Jun. 28, 2010

(51) Int. Cl. G06Q 30/00

(52) U.S. Cl. 705/14.14

(57) ABSTRACT

A reward based media distribution system, the system having a token generation system having a sales platform and a token server, a token redemption system having a token redemption platform and a token redemption server, and a drawing processor through which winners are selected. The reward based media distribution system will provide content creators and distributors with a device that will motivate the public through games of chance to purchase digital content rather that stealing it.

### BACKGROUND

The present invention relates generally to digital media distribution platforms and more specifically it relates to a reward based media distribution system for the purpose of providing content creators and distributors a tool that will motivate the public to buy content rather than stealing it.

Presently, the recording industry has used the legal system to prevent individuals from stealing music. The legal system has not deterred some music or movie pirates from copying the content and reselling it to the public at a reduced rate. In fact, a dramatic reduction in sales shows that, thanks to faster Internet downloading speeds and a proliferation of file sharing web sites, more people are downloading pirated music and movies.

The present approach used by content creators to deal with the theft of intellectual property is not working. Because of the proliferation of the Internet, the present distribution of content has proven to be inadequate.

The present invention proposes to change the delivery of content to the public by making it a reward based delivery system.

For the foregoing reasons there is a need for a reward based media distribution system that includes a token generation procedure, a token redemption procedure and a drawing process through which winners are selected.

### SUMMARY

The present invention is directed to a reward based media distribution system that includes a token generation procedure, a token redemption procedure and a drawing process through which winners are selected.

Some of the features of the present invention have been broadly described so that the detailed description may be better understood. There are additional features of the invention that will be further described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of the present invention is to provide content creators and distributors with a chance based reward system applied to digital media distribution. Content distributors and creators will use this system to motivate the public into buying content rather than stealing it.

Another object of the present invention is to provide the aforementioned reward based media distribution system with a unique token that will unequivocally identify each song, movie, or other digital media sold using the system.

Yet another object of the present invention is to provide digital media buyers using the system with an efficient manner for converting tokens into a number that will match a digital selection.

Another object of the present invention is to provide a reward based media distribution system that will associate each token and matching converted number(s) with a unique buyer.

### DRAWINGS

These and other features, aspects, and advantages of the present invention will become better understood with regard to the following description, appended claims, and drawings where:

FIG. 1 shows a diagram that describes the process through which a token is created;

FIG. 2 shows a flowchart that illustrates a sub-operation of the present invention: it describes the first section of the token redemption process; and

FIG. 3 shows a flowchart illustrating a sub-operation of the present invention: it describes the second and final section of the token redemption process;

FIG. 4 shows a flowchart of the present invention.

### DESCRIPTION

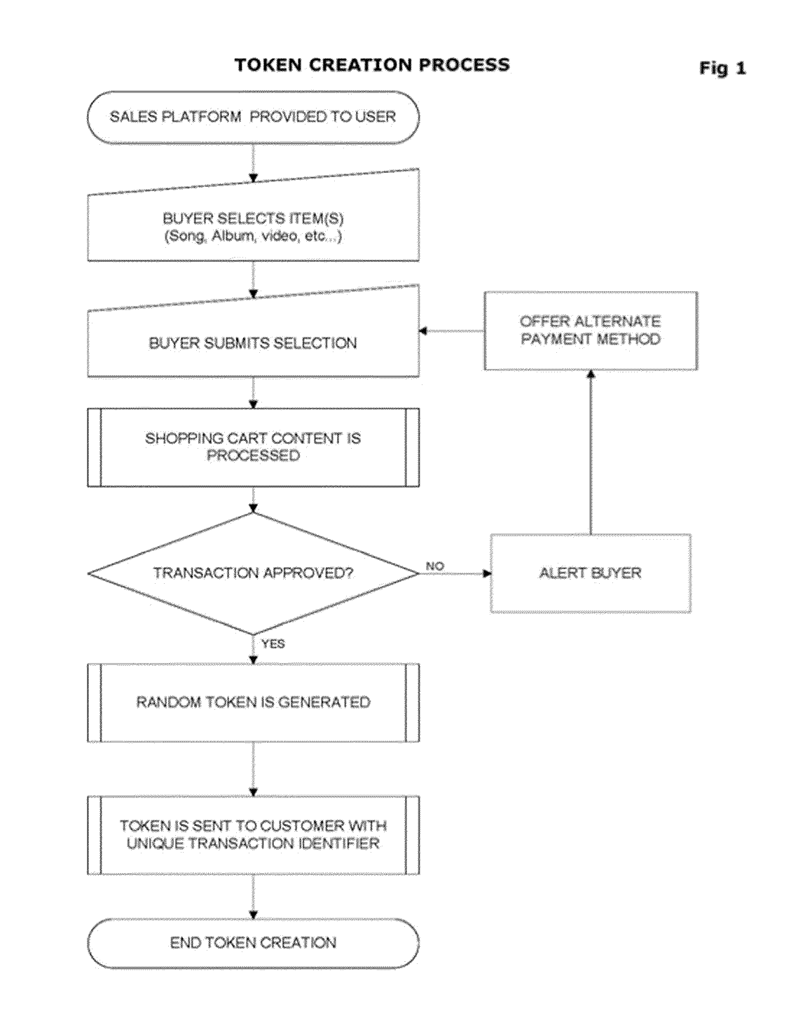

As shown in FIGS. 1-4, the figures illustrate a reward based media distribution system 100 that comprises of token generation system 10 having a sales platform 12 and a token server 14, a token redemption system 20 having a token redemption platform 22 and a token redemption server 24, the token redemption system 20 communicates with the token generation system 10, and a drawing processor 30, the drawing processor 30 communicates with the token redemption system 20.

As shown in FIG. 1, the token generation system 10 generates a token. This step can easily be integrated with the use of a shopping cart. It simply verifies that a sale has successfully completed before a token can be issued. Each token-transaction identification pair is unique and is tied to that particular transaction.

The token generation system 10 comprises the step of first providing a sales platform 12 that a user can access, then providing a user a means for selecting at least one item to purchase, next processing the items selected by the user and placing them in a digital shopping cart, then allowing the user to confirm the purchase of items in the shopping cart, then processing the payment for the items in the shopping cart, if the payment is approved, then a token is generated and the purchase is finalized, if the payment is rejected then alerting the user of rejection and allowing user to select an alternative mode of payment, lastly, after payment is approved, sending user at least one digital token with a unique identifier that user can use to enter into a drawing.

The sales platform 12 of the token generation system 10 can be a webpage or a physical digital delivery device such as a memory stick, USB, a CD, or any other type of device used to deliver digital content to an end user. After an item is purchased from the sales platform 12, a token will be generated from a token server 14 and issued to the user of the sales transaction. Tokens will be generated by the token servers 14 after verification of payment for the items purchased from the transaction. If in a retail environment, payment can be verified by swiping the bar code on the physical delivery device and the token server 14 would then activate a pre-printed token and possible unique identifier defined within the physical delivery device. If the sales platform 12 is a webpage, upon confirmation of payment, a token and possible unique identifier would be generated to the user of the webpage.

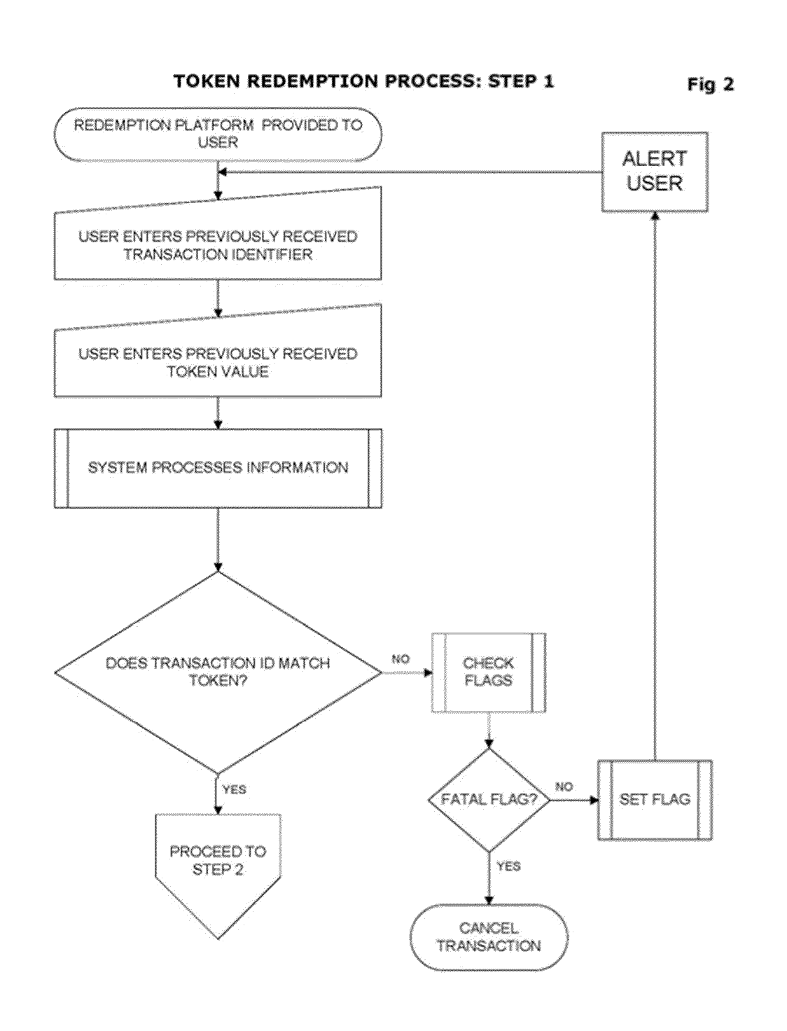

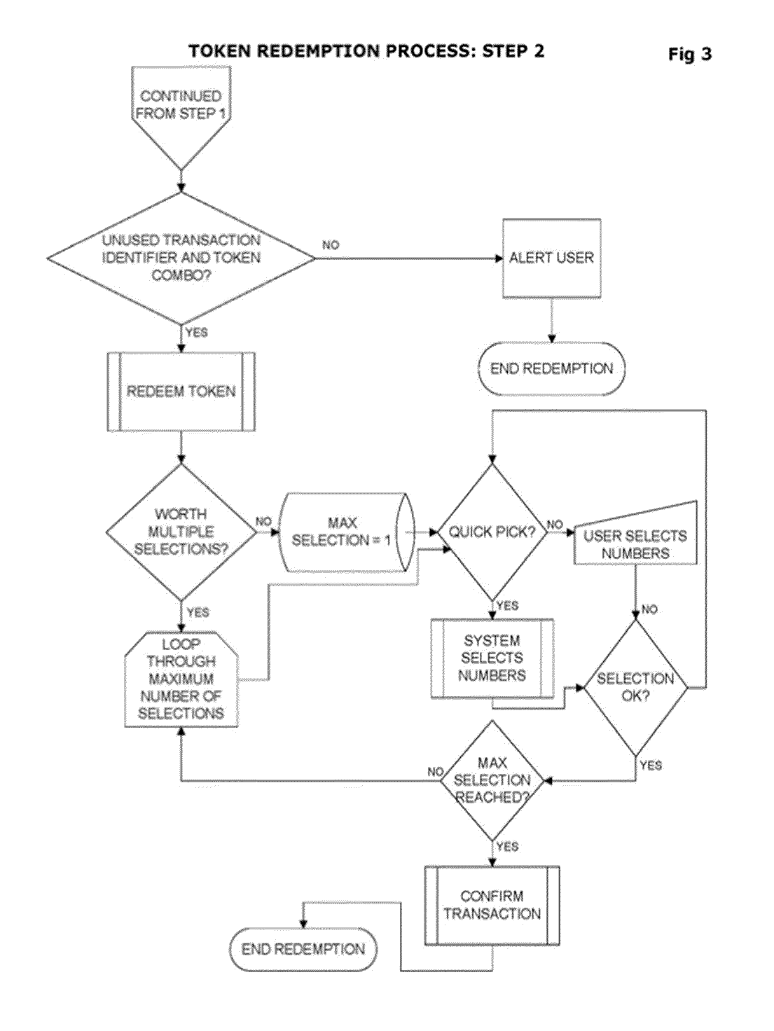

As seen in FIGS. 2-3, in the token redemption system 20 the token-unique identifier holder redeems his/her token in exchange of some numbers that he/she may choose or he/she may elect to let the token redemption system 20 choose for them. The range of those numbers will be subject to whichever guidelines are to be in place for the associated drawing procedure.

The token redemption system 20 comprises a token redemption platform 22, wherein a user can submit his token and possible unique identifier, then a token redemption server 24 would process the token and unique identifier for validity by communicating with the token server 14, if the token is invalid, the user is informed of the situation and given one or multiple chances to enter the correct information, the user cannot move past this step until a valid token is submitted, if the token is valid, then it is checked for prior usage, if the token is found to have been previously used, the user is informed of the situation and given one or multiple chances to submit a different token, the user cannot move past this step until a valid and unused token is submitted, upon the token redemption server 24 verifying that the token is valid and unused, the token redemption server 24 determines which instant reward, if any, the submitted token qualifies for. In lieu of or in conjunction with the instant reward, the token may only allow for a certain quantity of number selections by the user. If the token allows for number selection, the user will be allowed to select up to the quantity of numbers permitted by the submitted token(s). The selected number(s) will have to conform to a predefined limit and or pre-established pattern. Once all conditions are met, a confirmation is displayed on the screen and sent to the user.

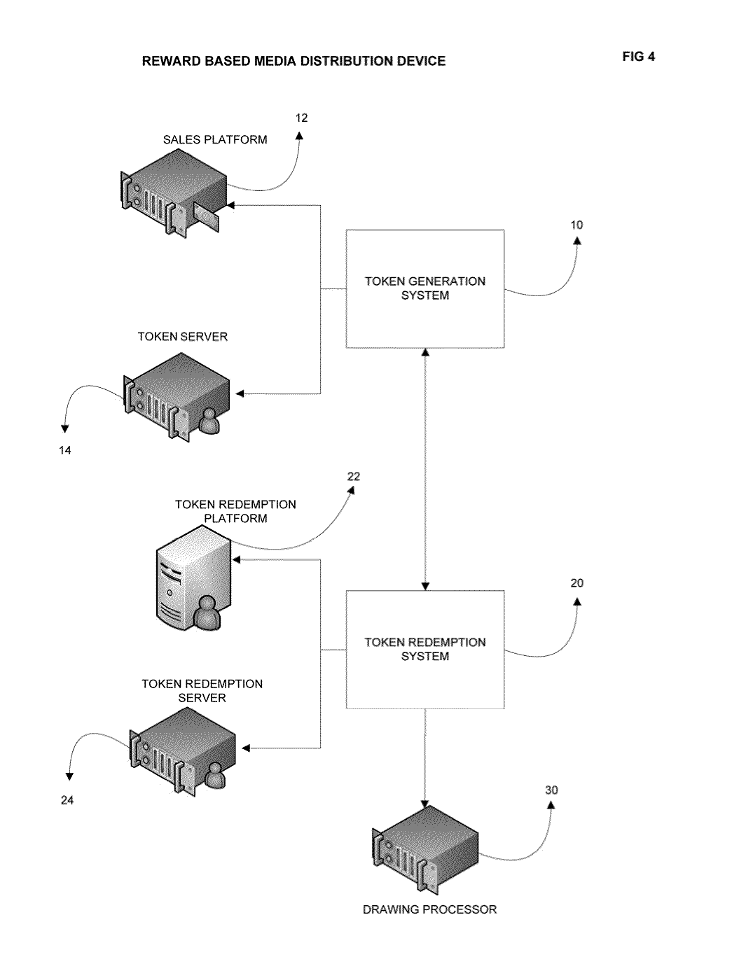

As seen in FIG. 4, the drawing processor 30 will conform to lottery drawing platforms currently used in any territory that allow lotteries. The numbers selected by the users would remain in the token redemption server 20 and until a drawing is completed by the drawing processor 30, upon a drawing being completed, users having winning numbers are awarded prizes.

The drawing processor 30 will be established by selected state lotteries and would use existing lottery drawing systems to select a winner. Lottery drawing systems are known in the art of lottery drawings. The inventor of the present invention prefers using existing drawing systems because he believes that it will allow organizers of the drawing system to gain maximum credibility amongst a skeptical public.

Using a preferred embodiment of the present invention, a user would purchase a song, movie, CD, DVD or other type of media whether on physical support or in purely digital form (download). Once funds are verified to be available, a token is issued. The token could be pulled from a database residing on the servers of the retailer or generated on the fly using a secret formula or pulled from a token server managed by an outside company. In the case of physical media distribution such as CD, DVD, Blue Ray, etc. . . . , the token could be preprinted inside the jacket or on the media support itself.

Once the token is issued, it is stored in a token server 14 and communicated to the token redemption server 24 along with a unique number representing the transaction identification number. The user then has to redeem his token and may use any available means such as web site interface, text messaging, IVR, etc. . . . The redemption process is a feature that makes the invention unique. It allows the user to choose his/her numbers instead of simply having them assigned to him/her. During that process, the validity of the token is verified. The system checks if that token was indeed created and associated with a transaction. If the combination of token and transaction identification is present in the token redemption database, the pair is further tested to verify that it was not previously claimed. Once verification is complete, the system may process the numbers selected by the user if they were sent over by text messaging or allow the user to enter his/her choice of numbers if the selection is being made through a web interface, IVR or other means where the user had not yet made his/her selection. Selected numbers are at that stage verified to make sure that they comply with a set pre-established format chosen beforehand. Upon completion of this process, with valid numbers accepted by the system, confirmation is sent to the buyer via picture or text messaging, email, telephone or any other mean allowing the user to keep a record of the transaction. The aforementioned confirmation will have all the necessary information with regards to numbers chosen as well as the date selected for a drawing.

The next and final step is the drawing which may or may not be held by the content creator or distributor or any other entity retained for that purpose. While content creators or distributors may elect to conduct their own drawing or retain an outside entity to conduct the drawing on their behalf, the ideal use, however, would be to have the drawing based on the winning numbers or portion of the winning numbers from a chosen state lottery in order to guarantee transparency. The winning lottery numbers would then be compared against those chosen by users and stored in the token redemption server. Winners will be chosen based on how closely their numbers match the winning lottery numbers. If the drawing were to be held by content creators, distributors or other entity retained for that purpose, the selection of the winner will be based on the same principle except that the winning numbers will be chosen from the available pool of numbers existing in the token redemption server.

An advantage of the present invention is that it provides content creators and distributors with a chance based reward system applied to digital media distribution. Content distributors and creators will use this system to motivate the public into buying content rather than stealing it.

Another advantage of the present invention is that it provides the aforementioned reward based media distribution system with a unique token that will unequivocally identify each song, movie, or other digital media sold using the system.

Yet another advantage of the present invention is that it provides digital media buyers using the system with an efficient manner for converting tokens into a number that will match a digital selection.

Another advantage of the present invention is that it provides a reward based media distribution system that will associate each token and matching converted number(s) with a unique buyer.

Although the present invention has been described in considerable detail with reference to certain preferred versions thereof, other versions are possible. Therefore the spirit and the scope of the claims should not be limited to the description of the preferred versions contained herein.

What is claimed is:

1. A reward based media distribution system, the system comprising:
a token generation system;
a token redemption system the communicates with the token generation system; and
a drawing processor that communicates with the token redemption system.

2. The reward media distribution system of claim 1, wherein the token generation system comprises:
A sales platform, wherein a user is provided a means for selecting at least one item to purchase; and
A token server connected to the sales platform, wherein the token server processes the items selected by the user and places them in a digital shopping cart, then allows the user to confirm the purchase of items in the shopping cart, then processes the payment for the items in the shopping cart, if the payment is approved, then a token is generated by the token server and delivered to the user and the purchase is finalized, if the payment is rejected then alerting the user of the rejection and allowing user to select an alternative mode of payment, lastly, after payment is approved by the token server, sending user at least one digital token with a unique identifier that user can use to enter into a drawing.

3. The reward media distribution system of claim 2, wherein the token redemption system comprises:
a token redemption platform, wherein a user can submit his token and possible unique identifier; and
a token redemption server, wherein the token redemption server would process the token and unique identifier for validity by communicating with the token server, if the token is invalid, the user is informed of the situation and given one or multiple chances to enter the correct information, the user cannot move past this step until a valid token is submitted, if the token is valid, then it is checked for prior usage, if the token is found to have been previously used, the user is informed of the situation and given one or multiple chances to submit a different token, the user cannot move past this step until a valid and unused token is submitted, upon the token redemption server verifying that the token is valid and unused, the token redemption server determines which instant reward, if any, the submitted token qualifies for.

4. The reward media distribution system of claim 3, wherein the drawing processor conforms to lottery drawing platforms currently used in any territory that allows lotteries.
